(19) United States
(12) Patent Application Publication
(10) Pub. No.: US 2026/0162866 A1
(43) Pub. Date: Jun. 11, 2026

(54) POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/414,049

(22) Filed: Dec. 9, 2025

(30) Foreign Application Priority Data
Dec. 10, 2024 (CN) 202411807890.7

(51) Int. Cl. H01F 27/00; H02M 3/00; H02M 3/335

(52) U.S. Cl. CPC H01F 27/006; H02M 3/003; H02M 3/335

(57) ABSTRACT

The present invention provides a circuit connection mode for a power conversion device, which can meet requirements of different gain ratios of input and output voltages and application scenarios of various output powers. Furthermore, with a simple magnetic core structure, a winding manner is provided, thereby further reducing the volume and loss of the magnetic assembly, and improving the power density of the power conversion device.

### CROSS-REFERENCE TO RELATED APPLICATION

This application claims the priority benefit of China application serial no. CN202411807890.7 filed on Dec. 10, 2024. The entirety of the above-mentioned patent application is hereby incorporated by reference herein and made a part of this specification.

### BACKGROUND

Description of Related Art

In recent years, with the development of artificial intelligence, the power requirements of artificial intelligence data processing chips, such as CPU, GPU, TPU, etc. (collectively, xPU) are increasingly high, so that the power of the server is increased, so that the power supply voltage of the server system board rises from 12V to 48V. In the occasion of the power supply voltage of the server system board is 48V, the two-stage buck circuit architecture has gradually become the mainstream.

The bus conversion device in the two-stage buck circuit architecture is a conversion device for realizing the voltage conversion between the input bus and the output bus, and the ratio of the input voltage to the output voltage is either a fixed gain ratio or an unfixed gain ratio. And a bus conversion device having a fixed gain ratio, provides an output voltage wherein an input voltage in a range of 40V-60V of the server mainboard is reduced to according to a ratio of 4:1 or 8:1 or 12:1, to supply a voltage regulator load that powers the artificial intelligence chip. With the increasing power consumption on the main board of the server, the power provided by the bus conversion device with the fixed gain ratio needs to be increased, and the requirements for power density and conversion efficiency are getting higher and higher.

The present invention provides a solution for a power conversion device with a fixed gain ratio, high power density and high conversion efficiency, comprising a circuit connection mode, a corresponding winding method, and a structure layout.

### SUMMARY

In view of the above, one of the objectives of the invention is to provide a power conversion device, comprising:
an input positive terminal, an input negative terminal, an output positive terminal, an output negative terminal, a high-voltage circuit, and a low-voltage circuit, wherein the high-voltage circuit comprises a first high-voltage sub-circuit, a second high-voltage sub-circuit, a resonant capacitor, and N high-voltage windings, N being a natural number greater than 1;
the first high-voltage sub-circuit comprises a first upper switch and a first middle switch, and the first upper switch and the first middle switch are electrically connected in series to a first upper node; the second high-voltage sub-circuit comprises a second upper switch and a second middle switch, and the second upper switch and the second middle switch are electrically connected in series to a second upper node; the first high-voltage sub-circuit and the second high-voltage sub-circuit are both electrically connected to the positive terminal; after the N high-voltage windings are connected in series, the N high-voltage windings are connected in series with a resonant capacitor and then are connected between the first upper node and the second upper node;
the low-voltage circuit comprises N low-voltage sub-circuits, each low-voltage sub-circuit comprising a first lower switch, a second lower switch, a first low-voltage winding and a second low-voltage winding; the first lower switch and the first low-voltage winding are electrically connected in series to a first lower node, and then connected between the output positive terminal and the output negative terminal; the second lower switch and the second low-voltage winding are electrically connected in series to a second lower node, and then connected between the output positive terminal and the output negative terminal;
the first middle switch is electrically connected to the input negative terminal or at least one first lower node, and the second middle switch is electrically connected to the input negative terminal or at least one second lower node.

Preferably, some or all of the N first lower switches are electrically connected in parallel, and some or all of the N second lower switches are electrically connected in parallel.

Preferably, the power conversion device, further comprising a magnetic core, wherein the magnetic core comprises an upper magnetic cover, a lower magnetic cover, an opposite first side and third side, an opposite second side and fourth side, and at least three magnetic columns,
wherein each of the at least three magnetic columns is arranged between the upper magnetic cover and the lower magnetic cover, the at least three magnetic columns are sequentially arranged in the same direction, and a winding channel is formed between every two adjacent magnetic columns;
the N high-voltage windings, the N first low-voltage windings, and the N second low-voltage windings are coupled in the same magnetic core; one high-voltage winding, one first low-voltage winding, and one second low-voltage winding constitute a transformer, the high-voltage winding, the first low-voltage winding and the second low-voltage winding constituting the same transformer pass through the same winding channel.

Preferably, the high-voltage winding is wound around all the magnetic columns or only around the middle magnetic column, and the first low-voltage winding and the second low-voltage winding in the same low-voltage sub-circuit pass through the same winding channel in an opposite direction from a first end to a second end.

Preferably, the first end of the first low-voltage winding and the second end of the second low-voltage winding are arranged adjacent to the first side of the magnetic core, the second end of the first low-voltage winding and the first end of the second low-voltage winding are arranged adjacent to the third side of the magnetic core, the first low-voltage winding passes through the winding channel from the first end to the second end in a second direction, and the second low-voltage winding passes through the winding channel in a first direction from the first end to the second end; or, the first end of the first low-voltage winding and the second end of the second low-voltage winding are arranged adjacent to the third side of the magnetic core, the second end of the first low-voltage winding and the first end of the second low-voltage winding are arranged adjacent to the first side of the magnetic core, the first low-voltage winding passes through the winding channel from the first end to the second end in the first direction, and the second low-voltage winding passes through the winding channel in the second direction from the first end to the second end.

Preferably, the power conversion device, further comprising a substrate, wherein the substrate comprises an upper surface and a lower surface opposite to each other and a plurality of holes, the holes penetrate through the upper surface and the lower surface, the magnetic columns respectively pass through the holes and are assembled with the upper magnetic cover and the lower magnetic cover, and the first lower switch and the second lower switch of the N low voltage sub-circuits are all arranged along sides of the magnetic core.

Preferably, sources of the N first lower switches and sources of the N second lower switches are shorted together by means of a copper pour surrounding the magnetic core, and form a GND network; second ends of the N first low voltage windings and the N second low voltage windings are shorted together by means of a copper pour surrounding the magnetic core, and form a Vo+ network.

Preferably, a first end of the first low-voltage winding is electrically connected to a drain of the first lower switch, a first end of the second low-voltage winding is electrically connected to a drain of the second lower switch, and the second end of the first low-voltage winding and the second end of the second low-voltage winding are connected to the Vo+ network nearby.

Preferably, the first lower switch and the second lower switch in the same low voltage sub-circuit are respectively located on the first side and the third side of the magnetic core, or both are located on the second side or the fourth side of the magnetic core.

Preferably, the power conversion device, further comprising at least N output capacitors, wherein the at least N output capacitors are located on a side of the magnetic core and adjacent to the first lower switch and/or the second lower switch of each low-voltage sub-circuit, and the output capacitor is connected across the Vo+ network and the GND network.

Preferably, the upper switch and the middle switch in the first high-voltage sub-circuit and the second high-voltage sub-circuit are both disposed adjacent to the first side of the magnetic core.

Preferably, the power conversion device, further comprising an input capacitor and an input terminal, wherein the input capacitor is connected across the input positive terminal and the input negative terminal, and the input capacitor is disposed adjacent to each of the high-voltage sub-circuits; and the input terminal is disposed on the lower surface of the substrate and is disposed adjacent to the input capacitor.

Preferably, the power conversion device, further comprising a resonant capacitor, wherein the resonant capacitor is adjacent to the switch in the first high-voltage sub-circuit or is disposed adjacent to the switch in the second high-voltage sub-circuit.

Preferably, an output capacitor is disposed on the lower surface of the substrate, and the output capacitor is disposed adjacent to the lower switch in each low-voltage sub-circuit; and further includes an output terminal disposed adjacent to at least one low-voltage sub-circuit.

Preferably, a cross-sectional area of the magnetic column located in the middle is greater than the cross-sectional area of the magnetic column located at the two ends.

Preferably, N is 4, and the high-voltage winding comprises a first high-voltage winding, a second high-voltage winding, a third high-voltage winding, and a fourth high-voltage winding;
the low-voltage sub-circuit comprises a first low-voltage sub-circuit, a second low-voltage sub-circuit, a third low-voltage sub-circuit, and a fourth low-voltage sub-circuit;
wherein the power conversion device further comprises a magnetic core, the magnetic core comprises an opposite first side and third side, an opposite second side and forth side, an upper magnetic cover, a lower magnetic cover, a first magnetic column, a second magnetic column, and a third magnetic column;
the first magnetic column, the second magnetic column, and the third magnetic column are arranged between the upper magnetic cover and the lower magnetic cover; the third magnetic column is arranged between the first magnetic column and the second magnetic column;
a cross-sectional area of the third magnetic column is greater than a cross-sectional area of the first magnetic column or the cross-sectional area of the second magnetic column; a first winding channel is provided between the first magnetic column and the third magnetic column, and a second winding channel is provided between the second magnetic column and the third magnetic column; the first magnetic column is disposed adjacent to the fourth side, and the second magnetic column is disposed adjacent to the second side.

Preferably, the first low-voltage winding and the second low-voltage winding in the first low-voltage sub-circuit respectively pass through the first winding channel once; the first low-voltage winding and the second low-voltage winding in the second low-voltage sub-circuit respectively pass through the second winding channel once; the first low-voltage winding and the second low-voltage winding in the third low-voltage sub-circuit respectively pass through the first winding channel once; the first low-voltage winding and the second low-voltage winding in the fourth low-voltage sub-circuit respectively pass through the second winding channel once.

Preferably, the first high-voltage winding is wound around the first magnetic column at least two circles; the second high-voltage winding is wound around the second magnetic column at least two circles; and the third high-voltage winding and the fourth high-voltage winding are connected in series and then wound around the third magnetic column at least two circles.

Preferably, the first high-voltage winding, the second high-voltage winding, the third high-voltage winding, and the fourth high-voltage winding are connected in series and then wound around the third magnetic column at least four circles.

Preferably, the power conversion device further comprises a substrate, the substrate comprises an upper surface and a lower surface opposite to each other, the lower switch of the first low-voltage sub-circuit is arranged along the fourth side of the magnetic core, and the lower switch in the second low-voltage sub-circuit is arranged along the second side of the magnetic core; the lower switch of the third low voltage sub-circuit is disposed along the first side and the third side of the magnetic core, respectively, and the lower switch in the fourth low voltage sub-circuit is disposed along the first side and the third side of the magnetic core, respectively.

Preferably, a first end of the first low-voltage winding of the first low-voltage sub-circuit and a second end of the second low-voltage winding of the first low-voltage sub-circuit are arranged adjacent to the first side of the magnetic core, a second end of the first low-voltage winding of the first low-voltage sub-circuit and a first end of the second low-voltage winding of the first low-voltage sub-circuit are arranged adjacent to the third side of the magnetic core, the first low-voltage winding of the first low-voltage sub-circuit passes through the first winding channel from the first end to the second end in a second direction, and the second low-voltage winding of the first low-voltage sub-circuit passes through the first winding channel from the first end to the second end in a first direction;

a second end of the first low-voltage winding of the second low-voltage sub-circuit and a first end of the second low-voltage winding of the second low-voltage sub-circuit are arranged adjacent to the first side of the magnetic core, a first end of the first low-voltage winding of the second low-voltage sub-circuit and a second end of the second low-voltage winding of the second low-voltage sub-circuit are arranged adjacent to the third side of the magnetic core, the first low-voltage winding in the second low-voltage sub-circuit passes through the second winding channel from the first end to the second end in the first direction, and the second low-voltage winding in the second low-voltage sub-circuit passes through the second winding channel in the second direction from the first end to the second end; a first end of the first low-voltage winding of the third low-voltage sub-circuit and a second end of the second low-voltage winding of the third low-voltage sub-circuit are arranged adjacent to the first side of the magnetic core, a second end of the first low-voltage winding of the third low-voltage sub-circuit and a first end of the second low-voltage winding of the third low-voltage sub-circuit are arranged adjacent to the third side of the magnetic core, the first low-voltage winding in the third low-voltage sub-circuit passes through the first winding channel from the first end to the second end in the second direction, and the second low-voltage winding in the third low-voltage sub-circuit passes through the first winding channel from the first end to the second end in the first direction; a second end of the first low-voltage winding of the fourth low-voltage sub-circuit and a first end of the second low-voltage winding of the fourth low-voltage sub-circuit are arranged adjacent to the first side of the magnetic core, a first end of the first low-voltage winding of the fourth low-voltage sub-circuit and a second end of the second low-voltage winding of the fourth low-voltage sub-circuit are arranged adjacent to the third side of the magnetic core, the first low-voltage winding of the fourth low-voltage sub-circuit passes through the second winding channel from the first end to the second end in the first direction, and the second low-voltage winding of the fourth low-voltage sub-circuit passes through the second winding channel from the first end to the second end in the second direction.

Preferably, a first end and a second end of the first high-voltage winding, the second high-voltage winding, the third high-voltage winding, and the fourth high-voltage winding are sequentially connected end-to-end;
the first end of the first high-voltage winding or the second end of the fourth high-voltage winding is electrically connected to the resonant capacitor and then respectively connected between the first upper node and the second upper node; the high-voltage winding is wound form the first end of the first high-voltage winding to the second end of the fourth high-voltage winding firstly around the first magnetic column in a counterclockwise direction at least two circles, and then wound around the third magnetic column in a clockwise direction at least two circles, and finally, wound around the second magnetic column in a counterclockwise direction at least two circles, the first end of the first high-voltage winding and the second end of the fourth high-voltage winding are both disposed adjacent to the first side of the magnetic core.

Preferably, a first end and a second end of the first high-voltage winding, the second high-voltage winding, the third high-voltage winding, and the fourth high-voltage winding are sequentially connected end-to-end; the first end of the first high-voltage winding or the second end of the fourth high-voltage winding is electrically connected to the resonant capacitor and then respectively connected between the first upper node and the second upper node;
the high-voltage winding is wound from the first end of the first high-voltage winding to the second end of the fourth high-voltage winding around the third magnetic column in a counterclockwise direction at least four circles, and the first end of the first high-voltage winding and the second end of the fourth high-voltage winding are both disposed adjacent to the same side of the magnetic core.

Preferably, a first end of each of the high-voltage windings, a second end of each of the first low-voltage windings, and a first end of each of the first low-voltage windings have the same polarity.

A power conversion device, comprising:
a high-voltage switch, a low-voltage switch, a magnetic core, a high-voltage winding, a first low-voltage winding and a second low-voltage winding; the high-voltage winding, the first low-voltage winding, and the second low-voltage winding are coupled in the magnetic core;
the magnetic core comprises an upper magnetic cover, a lower magnetic cover and a plurality of magnetic columns, the plurality of magnetic columns are arranged between the upper magnetic cover and the lower magnetic cover, and a winding channel is formed between two adjacent magnetic columns; one high-voltage winding, one first low-voltage winding and one second low-voltage winding constitute a transformer winding, the high-voltage winding, the first low-voltage winding, and the second low-voltage winding in the same transformer winding pass through the same winding channel;
the low-voltage switch comprises a first lower switch and a second lower switch; a first end of the first low-voltage winding is electrically connected with the first lower switch, a first end of the second low-voltage winding is electrically connected with the second lower switch; the first lower switch and the second lower switch are disposed at opposite sides of the magnetic core and adjacent to the two ends of the same winding channel; a second end of the first low-voltage winding and a second end of the second low-voltage winding are electrically connected; the high-voltage winding is electrically connected to the high-voltage switch.

Preferably, the magnetic core comprises a first side and a third side opposite to each other, and a second side and a fourth side opposite to each other, the magnetic column comprises a first magnetic column, a second magnetic column and a third magnetic column, the third magnetic column is arranged between the first magnetic column and the second magnetic column, a first winding channel is formed between the first magnetic column and the third magnetic column, a second winding channel is formed between the second magnetic column and the third magnetic column, and both the first winding channel and the second winding channel are provided with the high-voltage winding, the first low-voltage winding and the second low-voltage winding; a first end of the first low-voltage winding in the first winding channel and a second end of the second low-voltage winding in the first winding channel are arranged adjacent to the first side of the magnetic core, a second end of the first low-voltage winding in the first winding channel and a first end of the second low-voltage winding in the first winding channel are arranged adjacent to the third side of the magnetic core;
in the first winding channel, the first low-voltage winding passes through the first winding channel from the first end to the second end in a second direction, and the second low-voltage winding passes through the first winding channel in the first direction from the first end to the second end; the first end of the first low-voltage winding in the second winding channel and the second end of the second low-voltage winding located in the second winding channel are disposed adjacent to the third side of the magnetic core, the second end of the first low-voltage winding in the second winding channel and the first end of the second low-voltage winding in the second winding channel are disposed adjacent to the first side of the magnetic core;
in the second winding channel, the first low-voltage winding passes through the second winding channel from the first end to the second end in the first direction, and the second low-voltage winding passes through the second winding channel from the first end to the second end in the second direction.

Preferably, the high-voltage winding is wound around all the magnetic columns or only around the third magnetic column.

A power conversion device, comprising:
an input terminal, an output terminal, a substrate, a magnetic assembly, a high-voltage switch, and a low-voltage switch, wherein the input terminal, the output terminal, the magnetic assembly, the high-voltage switch, and the low-voltage switch are all disposed on a substrate;
the high-voltage switch is electrically connected to the input terminal and the magnetic assembly, and the low-voltage switch is electrically connected to the output terminal and the magnetic assembly; the magnetic assembly comprises a magnetic core and a winding, the magnetic core comprises a first side and a third side opposite to each other and an opposite second side and fourth side, and the winding comprises a low-voltage winding;
the low-voltage switch is arranged along the sides of the magnetic core, a source of the low-voltage switch is short-circuited together by means of a copper pour surrounding the magnetic core to form a GND network, a drain of the low-voltage switch is electrically connected to a first end of the low-voltage winding, and a second end of the low-voltage winding is shorted together by means of a copper pour around the magnetic core to form a Vo+ network.

Preferably, the low-voltage winding comprises a first low-voltage winding and a second low-voltage winding, the low-voltage switch comprises a first lower switch and a second lower switch, the first end of the first low-voltage winding is electrically connected to the drain of the first lower switch, the first end of the second low-voltage winding is electrically connected to the drain of the second lower switch, and the second end of the first low-voltage winding and the second end of the second low-voltage winding are connected to the Vo+network nearby.

Preferably, the first lower switch and the second lower switch are respectively located on the first side and the third side of the magnetic core, or both are located on the second side or the fourth side of the magnetic core.

Preferably, the winding further comprises a high-voltage winding, and the high-voltage winding is electrically connected to the high-voltage switch.

Preferably, the power conversion device, further comprising an output capacitor, wherein the output capacitor is located on a side of the magnetic core and is disposed adjacent to the low-voltage switch; and the output capacitor is connected across the Vo+ network and the GND network.

Compared with the prior art, the application has the following beneficial effects:
The present invention provides a circuit connection mode, which can meet requirements of different input-to-output voltage gain ratios and application scenarios of multiple output powers;
Furthermore, in combination with a simple magnetic core structure, a winding method for a winding is provided, thereby further reducing the volume and loss of the magnetic assembly; and improving the power density of the power conversion device.

### BRIEF DESCRIPTION OF THE DRAWINGS

FIG. 1A to FIG. 1C are schematic circuit diagrams of a bus conversion device.

FIG. 2A to FIG. 2D are magnetic core structures and winding methods.

FIG. 3A to FIG. 3D are schematic structural diagrams of a bus conversion device.

### DESCRIPTION OF THE EMBODIMENTS

One of the cores of the present invention is to provide a bus conversion device.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The present invention discloses a circuit of a bus conversion device, a winding manner, and an arrangement of parts.

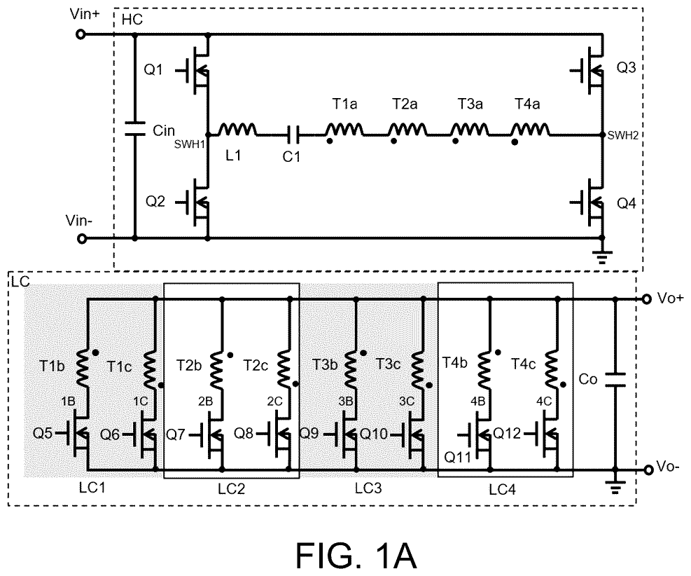

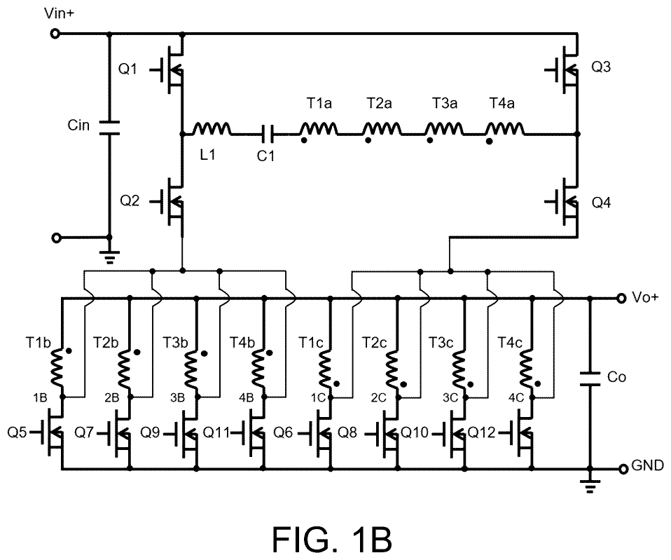

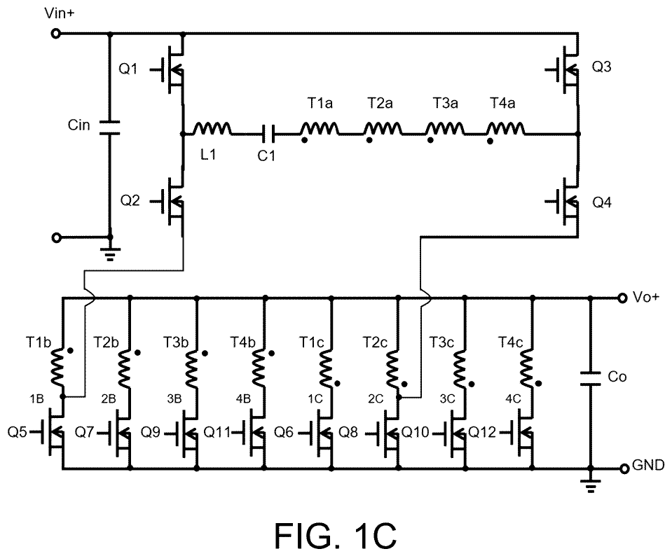

As shown in FIG. 1A to FIG. 1C, the circuit of the bus conversion device may be a circuit with high and low voltage separation as shown in FIG. 1A. In detail, as shown in FIG. 1A, the circuit with high and low voltage separation includes an input positive terminal Vin+, an input negative terminal Vin−, an output positive terminal Vo+, and an output negative terminal Vo−, and the input negative terminal Vin− and the output negative terminal Vo− may be disposed in isolation or shorted together. The high and low voltage separation circuit further comprises a high-voltage circuit HC and a low-voltage circuit LC; the high-voltage circuit HC comprises a first high-voltage sub-circuit, a second high-voltage sub-circuit, a resonant inductor L1, a resonant capacitor C1, a first high-voltage winding T1a, a second high-voltage winding T2a, a third high-voltage winding T3a, and a fourth high-voltage winding T4a. The first high-voltage sub-circuit includes a first upper switch Q1 and a first middle switch Q2 electrically connected in series, and the second high-voltage sub-circuit includes a second upper switch Q3 and a second middle switch Q4 electrically connected in series; the first high-voltage sub-circuit and the second high-voltage sub-circuit are connected in parallel and are connected across the input positive terminal Vin+ and the input negative terminal Vin−. Specifically, a drain of the first upper switch Q1 and a drain of the second upper switch Q3 are electrically connected to the input positive terminal Vin+, a source of the first middle switch Q2 and a source of the second middle switch Q4 are electrically connected to the input negative terminal Vin−, a source of the first upper switch Q1 and a drain of the first middle switch Q2 are electrically connected to a first upper node SWH1, a source of the second upper switch Q3 and a drain of the second middle switch Q4 are electrically connected to a second upper node SWH2. After a first end and a second end of the high-voltage windings T1a, T2a, T3a, and T4a are sequentially connected, a series branch comprising the high-voltage windings and the resonant capacitor C1 connecting in series is connected across the first upper node SWH1 and the second upper node SWH2. The first end of the high-voltage winding T1a is electrically connected to the first upper node SWH1, the second end of the high-voltage winding T4a is electrically connected to the second upper node SWH2 after being connected in series with the resonant inductor L1 and/or the resonant capacitor C1; or the first end of the high-voltage winding T1a is electrically connected to the first upper node after being connected in series with the resonant inductor L1 and/or the resonant capacitor C1, and the second end of the high-voltage winding T4a is electrically connected to the second upper node SWH2.

The low-voltage circuit LC comprises a first low-voltage sub-circuit LC1, a second low-voltage sub-circuit LC2, a third low-voltage sub-circuit LC3, and a fourth low-voltage sub-circuit LC4; each low-voltage sub-circuit comprises a first low-voltage winding, a second low-voltage winding, a first lower switch and a second lower switch; taking the first low voltage sub-circuit LC1 as an example, it's comprising a first low voltage winding T1b, a second low voltage winding T1c, a first lower switch Q5 and a second lower switch Q6; a source of the first lower switch Q5 and a source of the second lower switch Q6 are electrically connected to the output negative terminal Vo−, a drain of the first lower switch Q5 and a first end of the first low voltage winding T1b are electrically connected to a first lower node 1B, a drain of the second lower switch Q6 and a first end of the second low voltage winding T1c are electrically connected to a second lower node 1C, and a second end of the first low voltage winding T1b and a second end of the second low voltage winding T1c are electrically connected to the output positive terminal Vo+. The connection mode of the other low-voltage sub-circuits is the same as that of the first low-voltage sub-circuit, it can be inferred by analogy with reference to FIG. 1A, so that the drains of the first lower switches Q5, Q7, Q9 and Q11 and the first ends of the first low-voltage windings T1b, T2b, T3b, and T4b are electrically connected to the first lower nodes 1B, 2B, 3B, and 4B, respectively; the drains of the second lower switches Q6, Q8, Q10, Q12, and the first ends of the second low voltage windings T1c, T2c, T3c, and T4c are electrically connected to the second lower nodes 1C, 2C, 3C, and 4C, respectively. The first lower switches Q5, Q7, Q9 and Q11 in the low-voltage circuit LC can all be electrically connected in parallel, that is, the first lower nodes 1B, 2B, 3B and 4B are all shorted; any two or three of the four first lower switches can also be electrically connected in parallel; the second lower switches Q6, Q8, Q10 and Q12 can all be electrically connected in parallel, that is, the second lower nodes 1C, 2C, 3C, and 4C are all shorted; or any two or three of the four second lower switches can be electrically connected in parallel.

The magnetic assembly comprises high-voltage windings T1a, T2a, T3a, T4a, and low-voltage windings T1b, T1c, T2b, T2c, T3b, T3c, T4b, and T4c. The high-voltage windings and the low-voltage windings are coupled in the same magnetic core. The magnetic assembly comprises four transformers, which are a first transformer, a second transformer, a third transformer and a fourth transformer, respectively; the first transformer comprises the high-voltage winding T1a, the low-voltage winding T1b and the low-voltage winding T1c, that is, the high-voltage winding T1a, the low-voltage windings T1b and T1c are wound on the same magnetic column; the second transformer comprises the high-voltage winding T2a, the low-voltage winding T2b and the low-voltage winding T2c, that is, the high-voltage winding T2a, the low-voltage windings T2b and T2c are wound on the same magnetic column; the third transformer comprises the high-voltage winding T3a, the low-voltage winding T3b, and the low-voltage winding T3c, that is, the high-voltage winding T3a, the low-voltage winding T3b, and the low-voltage winding T3c are wound on the same magnetic column. The fourth transformer includes the high-voltage winding T4a, the low-voltage winding T4b and the low-voltage winding T4c, that is, the high-voltage winding T4a, the low-voltage winding T4b, and the low-voltage winding T4c are wound on the same magnetic column. The first end of each high-voltage winding T1a, T2a, T3a, and T4a, the second end of the first low-voltage winding in each low-voltage sub-circuit and the first end of the second low-voltage winding in each low-voltage sub-circuit have the same polarity, and are labeled as point ends.

The resonant inductor L1 in the high-voltage circuit HC may be an external inductor, or may be a summed value of the leakage inductance of the four transformers, or a combination of the external inductor and the leakage inductance. The resonant inductor L1 is connected in series on the series branch of the resonant capacitor C1 and the high-voltage windings. The high and low voltage separation circuit further comprises an input capacitor Cin and an output capacitor Co. The input capacitor Cin is connected between the input positive terminal Vin+ and the input negative terminal Vin−, and the output capacitor Co is connected across the output positive terminal Vo+and the output negative terminal Vo-.

The circuit of the bus conversion device can also use a circuit having a high and low voltage short-circuit circuit as shown in FIG. 1B and FIG. 1C. The components included in the high and low voltage short-circuit circuit are the same as those included in the high and low voltage separation circuit, and the difference is that the source of the first middle switch Q2 and the source of the second middle switch Q4 are electrically connected to the first lower node and the second lower node of the low-voltage circuit, respectively. As shown in FIG. 1B, the source of the first middle switch Q2 is electrically connected to the first lower nodes 1B, 2B, 3B, and 4B of the low-voltage circuit, the source of the second middle switch Q4 is electrically connected to the second lower node 1C, 2C, 3C, and 4C in the low-voltage circuit LC. As shown in FIG. 1C, the source of the first middle switch Q2 is electrically connected to the first lower node 1B, that is, the drain of the first lower switch Q5 in the first low-voltage sub-circuit LC1; the source of the second middle switch Q4 is electrically connected to the second lower node 2C, that is, the drain of the second lower switch Q8 in the second low voltage sub-circuit LC2; that is, the source of the first middle switch is electrically connected to at least one first lower node, and the source of the second middle switch is electrically connected to at least one second lower node. Other connection modes and magnetic assemblies are coupled in the same manner as those shown in FIG. 1A.

In this embodiment, take the circuit of four high-voltage windings combined with four low-voltage sub-circuits as an example for description. In other embodiments, N high-voltage windings may also be provided with N low-voltage sub-circuits, and N is a natural number greater than 1.

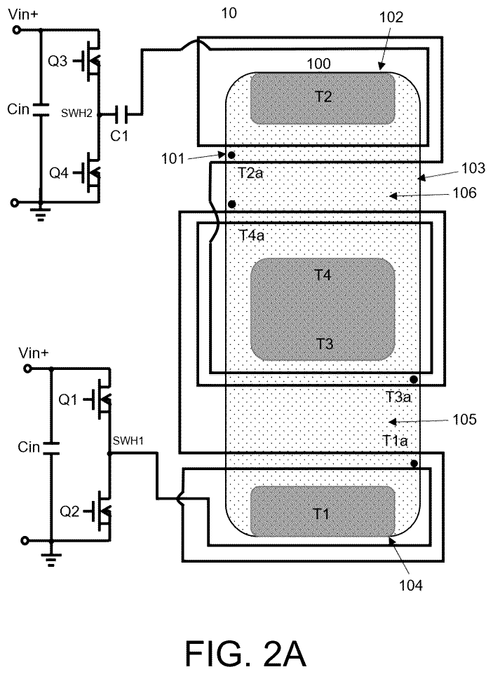

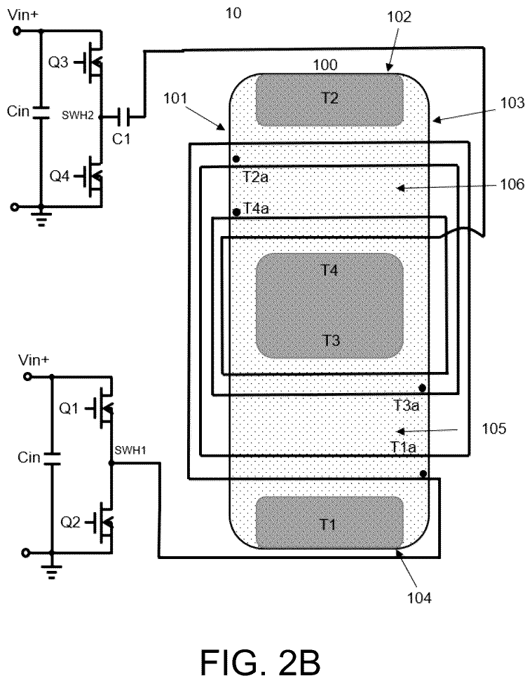

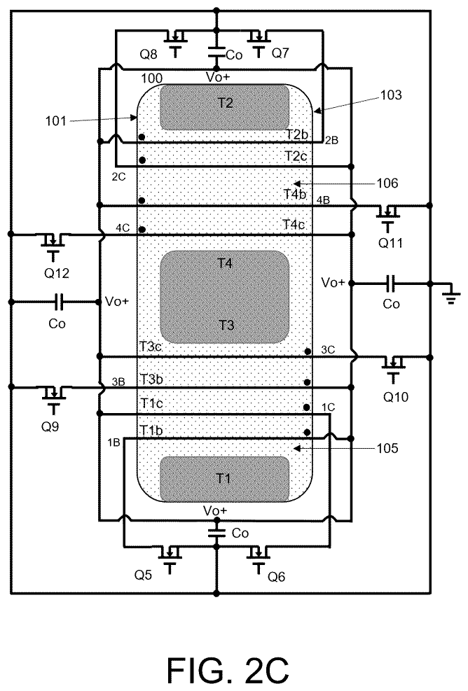

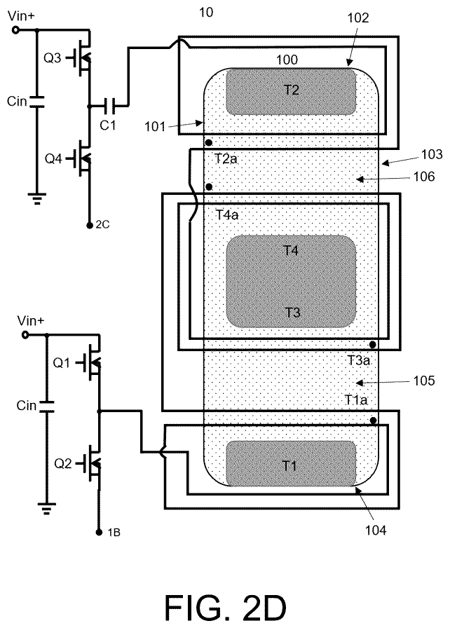

A winding manner of the windings and a structure of the magnetic assembly of the bus conversion device are further disclosed in the present invention, as shown in FIG. 2A to FIG. 2D. The magnetic assembly 10 comprises a magnetic core 100, a high-voltage winding and a low-voltage winding. The magnetic core 100 comprises a first side 101 and a third side 103 opposite to each other, a second side 102 and a fourth side 104 opposite to each other, and magnetic columns T1, T2, T3 and T4; the magnetic columns T2, T4, T3 and T1 are sequentially arranged in the same direction, wherein the magnetic column T2 is arranged adjacent to the second side 102, the magnetic column T1 is arranged adjacent to the fourth side 104, and the magnetic columns T3 and T4 are arranged between the magnetic columns T2 and T1. Further, the magnetic columns T3 and T4 may be integrated into one to form a magnetic column T3-T4, and the cross-sectional area of the magnetic column T3-T4 is twice the cross-sectional area of the magnetic column T2 or the magnetic column T1, that is, the magnetic core 100 adopts a three-column magnetic core. A channel between the magnetic column T1 and the magnetic column T3-T4 is defined as a winding channel 105, a channel between the magnetic column T2 and the magnetic column T3-T4 is defined as a winding channel 106. FIG. 2A is a winding manner of the high-voltage winding, from the first end of the high-voltage winding T1a to the second end of the high-voltage winding T4a, the high-voltage winding starts from the first upper node SWH1, firstly winding two circles around the magnetic column T1 in a counterclockwise direction, and then winding two circles around the magnetic column T3-T4 in a clockwise direction, and finally winding two circles around the magnetic column T2 in a counterclockwise direction, and then electrically connected to the second upper node SWH2. As shown in FIG. 2B, the present invention further provides another high-voltage winding manner, from the first end of the high-voltage winding T1a to the second end of the high-voltage winding T4a, the high-voltage winding starts from the first upper node SWH1, and is wound four circles around the magnetic column T3-T4 in the same direction (clockwise or counterclockwise), and then is electrically connected to the second upper node SWH2. The winding manner can further shorten the length of the winding and reduce the line loss. The principle of the winding manner of the high-voltage winding is that the high-voltage winding T1a passes through the winding channel 105 twice in a first direction (i.e., the direction from the third side 103 to the first side 101), the high-voltage winding T3a passes through the winding channel 105 twice in the first direction, the high-voltage winding T4a passes through the winding channel 106 twice in a second direction (i.e. the direction from the first side 101 to the third side 103), the high-voltage winding T2a passes through the winding channel 106 twice in the second direction. In FIGS. 2A and 2B, the first end of the high-voltage winding T1a and the second end of the high-voltage winding T4a are both disposed adjacent to the first side 101 of the magnetic core 100. The high-voltage windings of the four transformers are respectively wound on the three magnetic columns of one three-column magnetic core or the high-voltage windings of the four transformers are wound on the middle magnetic column, such that the integration of the four transformers is greatly improved, the volume of the magnetic assembly is reduced, and the utilization rate of the three-column magnetic core is improved.

FIG. 2C is a winding manner of the low-voltage winding, in the first low-voltage sub-circuit, the first end (equivalent to a first lower node 1B) of the first low-voltage winding T1b and the second end of the second low-voltage winding T1c are arranged adjacent to the first side 101 and the fourth side 104 of the magnetic core 100, and the second end of the first low-voltage winding T1b and the first end (equivalent to a second lower node 1C) of the second low-voltage winding T1c are arranged adjacent to the third side 103 and the fourth side 104 of the magnetic core; the first low-voltage winding T1b and the second low-voltage winding T1c in the first low-voltage sub-circuit are wound one circle around the magnetic column T1, respectively; or the first low-voltage winding T1b passes through the winding channel 105 once from the first end to the second end in the second direction, and the second low-voltage winding T1c passes through the winding channel 105 once from the first end to the second end in the first direction. In the second low-voltage sub-circuit, the second end of the first low-voltage winding T2b and the first end (equivalent to a second lower node 2C) of the second low-voltage winding T2c are disposed adjacent to the first side 101 and the second side 102 of the magnetic core 100, and the first end (i.e., the first lower node 2B) of the first low-voltage winding T2b and the second end of the second low-voltage winding T2c are disposed adjacent to the third side 103 and the second side 102 of the magnetic core 100; the first low-voltage winding T2b and the second low-voltage winding T2c are wound one circle around the magnetic column T2, respectively; or the first low-voltage winding T2b passes through the winding channel 106 once from the first end to the second end in the first direction, and the second low-voltage winding T2c passes through the winding channel 106 once in the second direction from the first end to the second end. In the third low-voltage sub-circuit, the first end (equivalent to a first lower node 3B) of the first low-voltage winding T3b and the second end of the second low-voltage winding T3c are arranged adjacent to the first side 101 of the magnetic core 100, and the second end of the first low-voltage winding T3b and the first end (equivalent to a second lower node 3C) of the second low-voltage winding T3c are arranged adjacent to the third side 103 of the magnetic core; the first low-voltage winding T3b and the second low-voltage winding T3c are wound half circle around the magnetic column T3-T4, respectively; or the first low-voltage winding T3b passes through the winding channel 105 once from the first end to the second end in the second direction, and the second low-voltage winding T3c passes through the winding channel 105 once in the first direction from the first end to the second end. In the fourth low-voltage sub-circuit, the second end of the first low-voltage winding T4b and the first end of the second low-voltage winding T4c (i.e., the second lower node 4C) are arranged adjacent to the first side 101 of the magnetic core 100, and the first end (i.e., the first lower node 4B) of the first low-voltage winding T4b and the second end of the second low-voltage winding T4c are arranged adjacent to the third side 103 of the magnetic core 100; the first low-voltage winding T4b and the second low-voltage winding T4c are wound half circle around the magnetic column T3-T4, respectively; or the first low-voltage winding T4b passes through the winding channel 106 once from the first end to the second end in the first direction, and the second low-voltage winding T4c passes through the winding channel 106 once in the second direction from the first end to the second end. In addition, in the present embodiment, the second ends of the eight low-voltage windings are short-circuited together by a copper pour surrounding the magnetic core 100 and form a Vo+ network; the sources of the eight lower switches are shorted together by a copper pour surrounding the magnetic core 100 and form a GND network; at least four output capacitors Co are connected across the Vo+ copper pour and the GND copper pour, and the four output capacitors are respectively located on four sides of the magnetic core 100; and each output capacitor Co is placed adjacent to the first lower switch and the second lower switch of each sub-circuit. The low-voltage windings of the four transformers are respectively wound on the three magnetic columns of one three-column magnetic core, thereby greatly improving the integration of the four transformers, and improving the utilization rate of the three-column magnetic core.

In the present disclosure, the difference between FIG. 2D and FIG. 2A is that the high-voltage circuit shown in FIG. 2A uses the circuit diagram shown in FIG. 1A, the sources of the switches Q2 and Q4 are electrically connected to the input negative terminal Vin−, and the input capacitor Cin is connected between the input positive terminal Vin+ and the input negative terminal Vin−. The high-voltage circuit shown in FIG. 2D uses the circuit diagram shown in FIG. 1C, the source of the first middle switch Q2 is electrically connected to the first lower node 1B, the source of the second middle switch Q4 is electrically connected to the second lower node 2C, and the input capacitor Cin is connected between the input positive terminal Vin+ and the input negative terminal Vin−. In addition, in other embodiments, the source of the first middle switch Q2 may be electrically connected to any one or more of the first lower nodes 1B, 2B, 3B, and 4B, the source of the second middle switch Q4 may be electrically connected to any one or more of the second lower nodes 1C, 2C, 3C, and 4C, for example, as shown in FIG. 1B, the source of the first middle switch Q2 is electrically connected to all the first lower nodes 1B, 2B, 3B, and 4B, and the source of the second middle switch Q4 is electrically connected to all the second lower nodes 1C, 2C, 3C, and 4C. The connection and winding manners of the low-voltage circuit shown in FIG. 2C are all applicable to FIG. 1A to FIG. 1C.

According to the magnetic core structure and the winding manner used in the present invention, the input-to-output voltage gain ratio is realized as 8:1 by connecting the high-voltage switches with at least part of the low-voltage switches in series and by connecting the low-voltage sub-circuits in parallel; in other embodiments, different input-to-output voltage gain ratios can be obtained by changing the number of winding turns of the high-voltage winding, and is suitable for the application of more bus conversion devices. In addition, the transformers are integrated in one magnetic core, and the low-voltage windings of the transformers T3 and T4 only need to be wound half circle, thereby reducing the impedance on the winding without increasing the loss of the magnetic core.

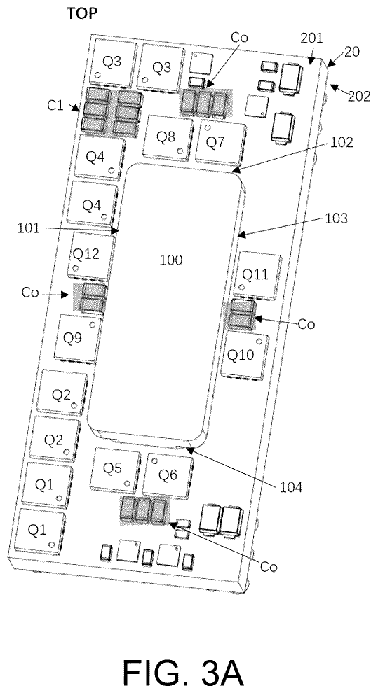

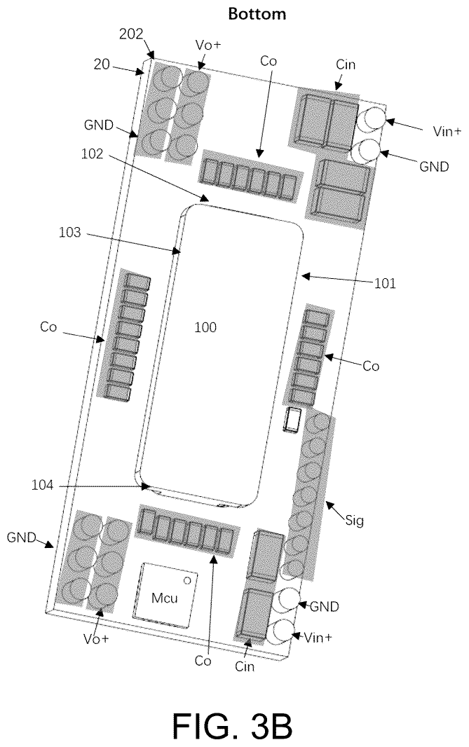

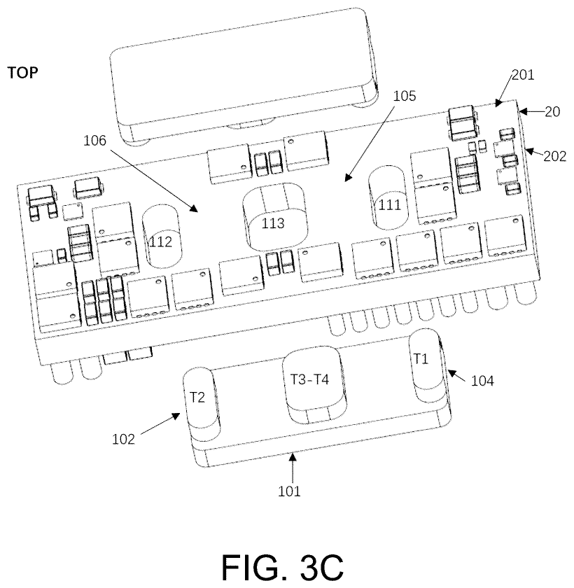

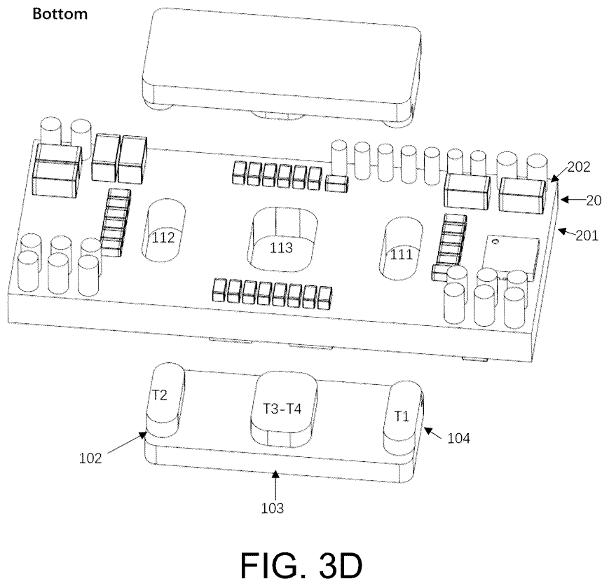

FIG. 3A to FIG. 3D are schematic structural diagrams of a bus conversion device, wherein FIG. 3A is a schematic top view structure diagram, FIG. 3B is a bottom view structure schematic diagram, FIG. 3C is a top view decomposition schematic diagram, and FIG. 3D is a bottom exploded view schematic diagram. With reference to FIGS. 3A, 3B, 3C and 3D, the bus conversion device comprises a substrate 20, the substrate 20 comprises an upper surface 201 and a lower surface 202 opposite to each other, and holes 111, 112 and 113; the holes 111, 112 and 113 penetrate through the upper surface 201 and the lower surface 202, the magnetic columns T1, T2 and T3-T4 respectively pass through the holes 111, 112 and 113, and the upper magnetic cover and the lower magnetic cover are assembled. The high voltage winding and the low voltage winding are disposed in the substrate 20. Corresponding to the circuit schematic shown in FIG. 1A or FIG. 1C, lower switches Q5 and Q6 in the first low voltage sub-circuit are arranged adjacent to the fourth side 104 of the magnetic core 100, and lower switches Q7 and Q8 in the second low voltage sub-circuit are arranged adjacent to the second side 102 of the magnetic core 100; the first lower switch Q9 in the third low voltage sub-circuit and the second lower switch Q12 in the fourth low voltage sub-circuit are arranged adjacent to the first side 101 of the magnetic core 100, the first lower switch Q11 in the fourth low voltage sub-circuit and the second lower switch Q10 in the third low voltage sub-circuit are arranged adjacent to the third side 103 of the magnetic core 100. The upper switch Q1 and the middle switch Q2 in the first high voltage sub-circuit are arranged on the first side 101 of the magnetic core 100 and are arranged adjacent to the fourth side 104 of the magnetic core 100; the upper switch Q3 and the middle switch Q4 in the second high voltage sub-circuit are arranged on the first side 101 of the magnetic core 100 and are arranged adjacent to the second side 102 of the magnetic core 100. The output capacitor Co and the resonant capacitor C1 are disposed on the upper surface 201 of the substrate 20; the output capacitor Co is respectively arranged on four sides of the magnetic core 100, and the output capacitor Co is respectively disposed adjacent to the lower switch of each low-voltage sub-circuit; specifically, the output capacitor Co is located between the first lower switch and the second lower switch; or the first lower switch and the second lower switch are arranged side by side, and the source thereof is adjacent to the output capacitor Co. The resonant capacitor C1 is disposed adjacent to the switch in the first high-voltage sub-circuit or is disposed adjacent to the switch in the second high-voltage sub-circuit.

The lower surface 201 of the substrate 20 is provided with an output capacitor Co, an input capacitor Cin, an output terminal Vo (an output positive terminal Vo+and a ground terminal GND), and an input terminal Vin (an input positive terminal Vin+and a ground terminal GND). The output capacitor Co is respectively arranged on four sides of the magnetic core 100, and the output capacitor Co is disposed directly below the lower switch in each low-voltage sub-circuit. The input terminals Vin are divided into two groups, which are arranged adjacent to the switches in the first high voltage sub-circuit and the switches in the second high voltage sub-circuit, and are respectively located on the outer sides of the second side 102 and the fourth side 104 of the magnetic core 100, and are symmetrically placed along the center line of the PCB. The output terminals Vo are divided into two groups, which are arranged adjacent to at least one low-voltage sub-circuit, and are respectively located on the outer sides of the second side 102 and the fourth side 104 of the magnetic core 100, and are symmetrically placed along the center line of the PCB. The bus conversion device further comprises a plurality of signal terminals Sig and a controller MCU. The lower switch in the low-voltage sub-circuit can be arranged on both the upper surface 201 and the lower surface 202 simultaneously, and satisfies the aligned relationship between upper and lower positions.

The winding manner of the windings and the layout structure disclosed in the present invention can further reduce the parasitic impedance on the power transmission path, reduce the loss on the power transmission path, further reduce the size of the bus conversion device, and improve the power density of the bus conversion device.

The switch disclosed by the application can be used for realizing the functions of the switch disclosed by the application, such as a Si MOSFET, SiC MOSFET, GaN MOSFET or IGBT MOSFET.

The technical features in the bus conversion device can be applied in the power conversion device, and can obtain the technical advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising:
an input positive terminal, an input negative terminal, an output positive terminal, an output negative terminal, a high-voltage circuit, and a low-voltage circuit, wherein the high-voltage circuit comprises a first high-voltage sub-circuit, a second high-voltage sub-circuit, a resonant capacitor, and N high-voltage windings, N being a natural number greater than 1;
the first high-voltage sub-circuit comprises a first upper switch and a first middle switch, and the first upper switch and the first middle switch are electrically connected in series to a first upper node; the second high-voltage sub-circuit comprises a second upper switch and a second middle switch, and the second upper switch and the second middle switch are electrically connected in series to a second upper node; the first high-voltage sub-circuit and the second high-voltage sub-circuit are both electrically connected to the positive terminal; after the N high-voltage windings are connected in series, the N high-voltage windings are connected in series with a resonant capacitor and then are connected between the first upper node and the second upper node;
the low-voltage circuit comprises N low-voltage sub-circuits, each low-voltage sub-circuit comprising a first lower switch, a second lower switch, a first low-voltage winding and a second low-voltage winding; the first lower switch and the first low-voltage winding are electrically connected in series to a first lower node, and then connected between the output positive terminal and the output negative terminal; the second lower switch and the second low-voltage winding are electrically connected in series to a second lower node, and then connected between the output positive terminal and the output negative terminal;
the first middle switch is electrically connected to the input negative terminal or at least one first lower node, and the second middle switch is electrically connected to the input negative terminal or at least one second lower node.

2. The power conversion device of claim 1, wherein some or all of the N first lower switches are electrically connected in parallel, and some or all of the N second lower switches are electrically connected in parallel.

3. The power conversion device of claim 1, further comprising a magnetic core, wherein the magnetic core comprises an upper magnetic cover, a lower magnetic cover, an opposite first side and third side, an opposite second side and fourth side, and at least three magnetic columns,
wherein the at least three magnetic columns are arranged between the upper magnetic cover and the lower magnetic cover, the at least three magnetic columns are sequentially arranged in the same direction, and a winding channel is formed between every two adjacent magnetic columns;
the N high-voltage windings, the N first low-voltage windings, and the N second low-voltage windings are coupled in the same magnetic core; one high-voltage winding, one first low-voltage winding, and one second low-voltage winding constitute a transformer, the high-voltage winding, the first low-voltage winding and the second low-voltage winding constituting the same transformer pass through the same winding channel.

4. The power conversion device of claim 3, wherein the high-voltage winding is wound around all the magnetic columns or only around the middle magnetic column, and the first low-voltage winding and the second low-voltage winding in the same low-voltage sub-circuit pass through the same winding channel in an opposite direction from a first end to a second end.

5. The power conversion device of claim 4, wherein the first end of the first low-voltage winding and the second end of the second low-voltage winding are arranged adjacent to the first side of the magnetic core, the second end of the first low-voltage winding and the first end of the second low-voltage winding are arranged adjacent to the third side of the magnetic core, the first low-voltage winding passes through the winding channel from the first end to the second end in a second direction, and the second low-voltage winding passes through the winding channel in a first direction from the first end to the second end; or, the first end of the first low-voltage winding and the second end of the second low-voltage winding are arranged adjacent to the third side of the magnetic core, the second end of the first low-voltage winding and the first end of the second low-voltage winding are arranged adjacent to the first side of the magnetic core, the first low-voltage winding passes through the winding channel from the first end to the second end in the first direction, and the second low-voltage winding passes through the winding channel in the second direction from the first end to the second end.

6. The power conversion device of claim 4, further comprising a substrate, wherein the substrate comprises an upper surface and a lower surface opposite to each other and a plurality of holes, the holes penetrate through the upper surface and the lower surface, the magnetic columns respectively pass through the holes and are assembled with the upper magnetic cover and the lower magnetic cover, and the first lower switch and the second lower switch of the N low voltage sub-circuits are all arranged along sides of the magnetic core.

7. The power conversion device of claim 6, wherein sources of the N first lower switches and sources of the N second lower switches are shorted together by means of a copper pour surrounding the magnetic core, and form a GND network; second ends of the N first low voltage windings and the N second low voltage windings are shorted together by means of a copper pour surrounding the magnetic core, and form a Vo+ network.

8. The power conversion device of claim 7, wherein a first end of the first low-voltage winding is electrically connected to a drain of the first lower switch, a first end of the second low-voltage winding is electrically connected to a drain of the second lower switch, and the second end of the first low-voltage winding and the second end of the second low-voltage winding are connected to the Vo+ network nearby.

9. The power conversion device of claim 6, wherein the first lower switch and the second lower switch in the same low voltage sub-circuit are respectively located on the first side and the third side of the magnetic core, or both are located on the second side or the fourth side of the magnetic core.

10. The power conversion device of claim 7, further comprising at least N output capacitors, wherein the at least N output capacitors are located on a side of the magnetic core and adjacent to the first lower switch and/or the second lower switch of each low-voltage sub-circuit, and the output capacitor is connected across the Vo+ network and the GND network.

11. The power conversion device of claim 6, wherein the upper switch and the middle switch in the first high-voltage sub-circuit and the second high-voltage sub-circuit are both disposed adjacent to the first side of the magnetic core.

12. The power conversion device of claim 11, further comprising an input capacitor and an input terminal, wherein the input capacitor is connected across the input positive terminal and the input negative terminal, and the input capacitor is disposed adjacent to each of the high-voltage sub-circuits; and the input terminal is disposed on the lower surface of the substrate and is disposed adjacent to the input capacitor.

13. The power conversion device of claim 11, further comprising a resonant capacitor, wherein the resonant capacitor is adjacent to the switch in the first high-voltage sub-circuit or is disposed adjacent to the switch in the second high-voltage sub-circuit.

14. The power conversion device of claim 6, wherein an output capacitor is disposed on the lower surface of the substrate, and the output capacitor is disposed adjacent to the lower switch in each low-voltage sub-circuit; and further includes an output terminal disposed adjacent to at least one low-voltage sub-circuit.

15. The power conversion device of claim 3, wherein a cross-sectional area of the magnetic column located in the middle is greater than the cross-sectional area of the magnetic column located at the two ends.

16. The power conversion device of claim 1, wherein N is 4, and the high-voltage winding comprises a first high-voltage winding, a second high-voltage winding, a third high-voltage winding, and a fourth high-voltage winding;
the low-voltage sub-circuit comprises a first low-voltage sub-circuit, a second low-voltage sub-circuit, a third low-voltage sub-circuit, and a fourth low-voltage sub-circuit;
wherein the power conversion device further comprises a magnetic core, the magnetic core comprises an opposite first side and third side, an opposite second side and forth side, an upper magnetic cover, a lower magnetic cover, a first magnetic column, a second magnetic column, and a third magnetic column;
the first magnetic column, the second magnetic column, and the third magnetic column are arranged between the upper magnetic cover and the lower magnetic cover; the third magnetic column is arranged between the first magnetic column and the second magnetic column;
a cross-sectional area of the third magnetic column is greater than a cross-sectional area of the first magnetic column or the cross-sectional area of the second magnetic column; a first winding channel is provided between the first magnetic column and the third magnetic column, and a second winding channel is provided between the second magnetic column and the third magnetic column; the first magnetic column is disposed adjacent to the fourth side, and the second magnetic column is disposed adjacent to the second side.

17. The power conversion device of claim 16, wherein the first low-voltage winding and the second low-voltage winding in the first low-voltage sub-circuit respectively pass through the first winding channel once; the first low-voltage winding and the second low-voltage winding in the second low-voltage sub-circuit respectively pass through the second winding channel once; the first low-voltage winding and the second low-voltage winding in the third low-voltage sub-circuit respectively pass through the first winding channel once; the first low-voltage winding and the second low-voltage winding in the fourth low-voltage sub-circuit respectively pass through the second winding channel once.

18. The power conversion device of claim 17, wherein the first high-voltage winding is wound around the first magnetic column at least two circles; the second high-voltage winding is wound around the second magnetic column at least two circles; and the third high-voltage winding and the fourth high-voltage winding are connected in series and then wound around the third magnetic column at least two circles.

19. The power conversion device of claim 17, wherein the first high-voltage winding, the second high-voltage winding, the third high-voltage winding, and the fourth high-voltage winding are connected in series and then wound around the third magnetic column at least four circles.

20. The power conversion device of claim 19, wherein the power conversion device further comprises a substrate, the substrate comprises an upper surface and a lower surface opposite to each other, the lower switch of the first low-voltage sub-circuit is arranged along the fourth side of the magnetic core, and the lower switch in the second low-voltage sub-circuit is arranged along the second side of the magnetic core; the lower switch of the third low voltage sub-circuit is disposed along the first side and the third side of the magnetic core, respectively, and the lower switch in the fourth low voltage sub-circuit is disposed along the first side and the third side of the magnetic core, respectively.

21. The power conversion device of claim 20, wherein a first end of the first low-voltage winding of the first low-voltage sub-circuit and a second end of the second low-voltage winding of the first low-voltage sub-circuit are arranged adjacent to the first side of the magnetic core, a second end of the first low-voltage winding of the first low-voltage sub-circuit and a first end of the second low-voltage winding of the first low-voltage sub-circuit are arranged adjacent to the third side of the magnetic core, the first low-voltage winding of the first low-voltage sub-circuit passes through the first winding channel from the first end to the second end in a second direction, and the second low-voltage winding of the first low-voltage sub-circuit passes through the first winding channel from the first end to the second end in a first direction;
a second end of the first low-voltage winding of the second low-voltage sub-circuit and a first end of the second low-voltage winding of the second low-voltage sub-circuit are arranged adjacent to the first side of the magnetic core, a first end of the first low-voltage winding of the second low-voltage sub-circuit and a second end of the second low-voltage winding of the second low-voltage sub-circuit are arranged adjacent to the third side of the magnetic core, the first low-voltage winding in the second low-voltage sub-circuit passes through the second winding channel from the first end to the second end in the first direction, and the second low-voltage winding in the second low-voltage sub-circuit passes through the second winding channel in the second direction from the first end to the second end; a first end of the first low-voltage winding of the third low-voltage sub-circuit and a second end of the second low-voltage winding of the third low-voltage sub-circuit are arranged adjacent to the first side of the magnetic core, a second end of the first low-voltage winding of the third low-voltage sub-circuit and a first end of the second low-voltage winding of the third low-voltage sub-circuit are arranged adjacent to the third side of the magnetic core, the first low-voltage winding in the third low-voltage sub-circuit passes through the first winding channel from the first end to the second end in the second direction, and the second low-voltage winding in the third low-voltage sub-circuit passes through the first winding channel from the first end to the second end in the first direction; a second end of the first low-voltage winding of the fourth low-voltage sub-circuit and a first end of the second low-voltage winding of the fourth low-voltage sub-circuit are arranged adjacent to the first side of the magnetic core, a first end of the first low-voltage winding of the fourth low-voltage sub-circuit and a second end of the second low-voltage winding of the fourth low-voltage sub-circuit are arranged adjacent to the third side of the magnetic core, the first low-voltage winding of the fourth low-voltage sub-circuit passes through the second winding channel from the first end to the second end in the first direction, and the second low-voltage winding of the fourth low-voltage sub-circuit passes through the second winding channel from the first end to the second end in the second direction.

22. The power conversion device of claim 18, wherein a first end and a second end of the first high-voltage winding, the second high-voltage winding, the third high-voltage winding, and the fourth high-voltage winding are sequentially connected end-to-end;
the first end of the first high-voltage winding or the second end of the fourth high-voltage winding is electrically connected to the resonant capacitor and then respectively connected between the first upper node and the second upper node; the high-voltage winding is wound form the first end of the first high-voltage winding to the second end of the fourth high-voltage winding firstly around the first magnetic column in a counterclockwise direction at least two circles, and then wound around the third magnetic column in a clockwise direction at least two circles, and finally, wound around the second magnetic column in a counterclockwise direction at least two circles, the first end of the first high-voltage winding and the second end of the fourth high-voltage winding are both disposed adjacent to the first side of the magnetic core.

23. The power conversion device of claim 21, wherein a first end and a second end of the first high-voltage winding, the second high-voltage winding, the third high-voltage winding, and the fourth high-voltage winding are sequentially connected end-to-end; the first end of the first high-voltage winding or the second end of the fourth high-voltage winding is electrically connected to the resonant capacitor and then respectively connected between the first upper node and the second upper node;
the high-voltage winding is wound from the first end of the first high-voltage winding to the second end of the fourth high-voltage winding around the third magnetic column in a counterclockwise direction at least four circles, and the first end of the first high-voltage winding and the second end of the fourth high-voltage winding are both disposed adjacent to the same side of the magnetic core.

24. The power conversion device of claim 1, wherein a first end of each of the high-voltage windings, a second end of each of the first low-voltage windings, and a first end of each of the first low-voltage windings have the same polarity.

25. A power conversion device, comprising:
a high-voltage switch, a low-voltage switch, a magnetic core, a high-voltage winding, a first low-voltage winding and a second low-voltage winding; the high-voltage winding, the first low-voltage winding, and the second low-voltage winding are coupled in the magnetic core;
the magnetic core comprises an upper magnetic cover, a lower magnetic cover and a plurality of magnetic columns, the plurality of magnetic columns are arranged between the upper magnetic cover and the lower magnetic cover, and a winding channel is formed between two adjacent magnetic columns; one high-voltage winding, one first low-voltage winding and one second low-voltage winding constitute a transformer winding, the high-voltage winding, the first low-voltage winding, and the second low-voltage winding in the same transformer winding pass through the same winding channel;
the low-voltage switch comprises a first lower switch and a second lower switch; a first end of the first low-voltage winding is electrically connected with the first lower switch, a first end of the second low-voltage winding is electrically connected with the second lower switch; the first lower switch and the second lower switch are disposed at opposite sides of the magnetic core and adjacent to the two ends of the same winding channel; a second end of the first low-voltage winding and a second end of the second low-voltage winding are electrically connected; the high-voltage winding is electrically connected to the high-voltage switch.

26. The power conversion device of claim 25, wherein the magnetic core comprises a first side and a third side opposite to each other, and a second side and a fourth side opposite to each other, the magnetic column comprises a first magnetic column, a second magnetic column and a third magnetic column, the third magnetic column is arranged between the first magnetic column and the second magnetic column, a first winding channel is formed between the first magnetic column and the third magnetic column, a second winding channel is formed between the second magnetic column and the third magnetic column, and both the first winding channel and the second winding channel are provided with the high-voltage winding, the first low-voltage winding and the second low-voltage winding; a first end of the first low-voltage winding in the first winding channel and a second end of the second low-voltage winding in the first winding channel are arranged adjacent to the first side of the magnetic core, a second end of the first low-voltage winding in the first winding channel and a first end of the second low-voltage winding in the first winding channel are arranged adjacent to the third side of the magnetic core;
in the first winding channel, the first low-voltage winding passes through the first winding channel from the first end to the second end in a second direction, and the second low-voltage winding passes through the first winding channel in the first direction from the first end to the second end; the first end of the first low-voltage winding in the second winding channel and the second end of the second low-voltage winding located in the second winding channel are disposed adjacent to the third side of the magnetic core, the second end of the first low-voltage winding in the second winding channel and the first end of the second low-voltage winding in the second winding channel are disposed adjacent to the first side of the magnetic core;
in the second winding channel, the first low-voltage winding passes through the second winding channel from the first end to the second end in the first direction, and the second low-voltage winding passes through the second winding channel from the first end to the second end in the second direction.

27. The power conversion device of claim 26, wherein the high-voltage winding is wound around all the magnetic columns or only around the third magnetic column.

28. A power conversion device, comprising:
an input terminal, an output terminal, a substrate, a magnetic assembly, a high-voltage switch, and a low-voltage switch, wherein the input terminal, the output terminal, the magnetic assembly, the high-voltage switch, and the low-voltage switch are all disposed on a substrate;
the high-voltage switch is electrically connected to the input terminal and the magnetic assembly, and the low-voltage switch is electrically connected to the output terminal and the magnetic assembly; the magnetic assembly comprises a magnetic core and a winding, the magnetic core comprises a first side and a third side opposite to each other and an opposite second side and fourth side, and the winding comprises a low-voltage winding;
the low-voltage switch is arranged along the sides of the magnetic core, a source of the low-voltage switch is short-circuited together by means of a copper pour surrounding the magnetic core to form a GND network, a drain of the low-voltage switch is electrically connected to a first end of the low-voltage winding, and a second end of the low-voltage winding is shorted together by means of a copper pour around the magnetic core to form a Vo+ network.

29. The power conversion device of claim 28, wherein the low-voltage winding comprises a first low-voltage winding and a second low-voltage winding, the low-voltage switch comprises a first lower switch and a second lower switch, the first end of the first low-voltage winding is electrically connected to the drain of the first lower switch, the first end of the second low-voltage winding is electrically connected to the drain of the second lower switch, and the second end of the first low-voltage winding and the second end of the second low-voltage winding are connected to the Vo+ network nearby.

30. The power conversion device of claim 29, wherein the first lower switch and the second lower switch are respectively located on the first side and the third side of the magnetic core, or both are located on the second side or the fourth side of the magnetic core.

31. The power conversion device of claim 29, wherein the winding further comprises a high-voltage winding, and the high-voltage winding is electrically connected to the high-voltage switch.

32. The power conversion device of claim 28, further comprising an output capacitor, wherein the output capacitor is located on a side of the magnetic core and is disposed adjacent to the low-voltage switch; and the output capacitor is connected across the Vo+ network and the GND network.
